(19) United States
(12) Patent Application Publication
(10) Pub. No.: US 2006/0064311 A1
(43) Pub. Date: Mar. 23, 2006

(54) High speed postage metering device and method utilizing a single postal security device with multiple printing modules

(75) Inventors: Walter J. Baker, Stratford, CT (US); Konstantin G. Kodonas, Norwalk, CT (US); John H. Steinmetz, Bridgeport, CT (US)

Correspondence Address: Brian A. Lemm;Pitney Bowes Inc., 35 Waterview DriveI, P.O. Box 3000, Shelton, CT, 06484, US

(73) Assignee: Pitney Bowes Incorporated, Stamford, CT (US)

(21) Appl. No.: 10/945,129

(22) Filed: Sep. 20, 2004

(51) Int. Cl. G06Q 99/00; H04M 15/00; G07F 19/00

(52) U.S. Cl. 705/1; 705/34

(57) ABSTRACT

A high speed mailing system that utilizes a single postal security (PSD) device in conjunction with multiple printing modules is provided. The control unit with which the PSD is associated is coupled to each of the printing modules through a multiplexer capable of switching between each of the printing modules. During initialization of the system for each mail processing session, the control unit establishes a secure communication session with each printing module individually through the multiplexer. Thus, the control unit can generate and provide indicia that can be printed only on the specific printing module that is currently in use. The multiplexer can switch between printing modules during operation of the mailing system, thereby always keeping one printing module in use while allowing the printing module that is not currently being used to perform any necessary maintenance operations, without having to stop the processing of mail pieces.

### FIELD OF THE INVENTION

The invention disclosed herein relates generally to mailing systems, and more particularly to high speed mail processing systems that utilize multiple printing modules for printing indicia on mail pieces.

### BACKGROUND OF THE INVENTION

Mail processing systems for preparing mail pieces, e.g., stuffing envelopes, and/or printing postage indicia on envelopes and other forms of mail pieces have long been well known and have enjoyed considerable commercial success. There are many different types of mail processing systems, ranging from relatively small units that handle only one mail piece at a time, to large, multi-functional units that can process thousands of mail pieces per hour in a continuous stream operation. The larger mailing machines often include different modules that automate the processes of producing mail pieces, each of which performs a different task on the mail piece. The mail piece is conveyed downstream utilizing a transport mechanism, such as rollers or a belt, to each of the modules. Such modules could include, for example, a singulating module, i.e., separating a stack of mail pieces such that the mail pieces are conveyed one at a time along the transport path, a moistening/sealing module, i.e., wetting and closing the glued flap of an envelope, a weighing module, and a metering module, i.e., applying evidence of postage to the mail piece. The exact configuration of the mailing machine is, of course, particular to the needs of the user.

Typically, a control device, such as, for example, a microprocessor, performs user interface and controller functions for the mail processing system. Specifically, the control device provides all user interfaces, executes control of the mail processing system and print operations, calculates postage for debit based upon rate tables, provides the conduit for the Postal Security Device (PSD) to transfer postage indicia to the printer, operates with peripherals for accounting, printing and weighing, and conducts communications with a data center for postage funds refill, software download, rates download, and market-oriented data capture. The control device, in conjunction with an embedded PSD, constitutes the system meter that satisfies U.S. information-based indicia postage meter requirements and other international postal regulations regarding closed system meters. The United States Postal Service (USPS) initiated the Information-Based Indicia Program (IBIP) to enhance the security of postage metering by supporting new methods of applying postage to mail. The USPS has published draft specifications for the IBIP. The requirements for a closed system are defined in the “Performance Criteria for Information-Based Indicia and Security Architecture for Closed IBI Postage Metering System (PCIBI-C),” dated Jan. 12, 1999. A closed system is a system whose basic components are dedicated to the production of information-based indicia and related functions, similar to an existing, traditional postage meter. A closed system, which may be a proprietary device used alone or in conjunction with other closely related, specialized equipment, includes the indicia print mechanism.

The PCIBI-C specification defines the requirements for the indicium to be applied to mail produced by closed systems. The indicium consists of a two-dimensional (2D) barcode and certain human-readable information. Some of the data included in the barcode includes, for example, the PSD manufacturer identification, PSD model identification, PSD serial number, values for the ascending and descending registers of the PSD, postage amount, and date of mailing. In addition, a digital signature is required to be created by the PSD for each mail piece and placed in the digital signature field of the barcode. Several types of digital signature algorithms are supported by the IBIP, including, for example, the Digital Signature Algorithm (DSA), the Rivest Shamir Adleman (RSA) Algorithm, and the Elliptic Curve Digital Signature Algorithm (ECDSA).

Modern mail processing systems utilize digital printing techniques for producing images on a mail piece. Conventional digital printing techniques include bubble jet and ink jet, each of which produces an image in a dot matrix pattern. With digital printing, individual print head elements (such as resistors or piezoelectric elements) are selectively electronically stimulated to expel drops of ink from a reservoir onto a substrate, e.g., a mail piece. In either case, by controlling the timing of energizing of the individual print head elements in conjunction with the relative movement between the print head and the mail piece, a dot matrix pattern is produced in the visual form of the desired image. In the case of mail processing systems, the image may be, for example, an indicium that evidences payment of postage.

Digital printing technology has significant advantages when used in a mail processing system as compared to older technology that utilized either a flat platen or a rotary drum to imprint information, such as, for example, address information or an indicium, on mail pieces. For example, if some variable image data needs to be changed, it can easily be done through the installation of new or upgraded software versus having to replace the entire printing module, since the flat platen and drum are typically not separately removable. Moreover, greater printing speeds can be obtained as compared to conventional mechanical printing systems.

The use of a digital printing technology in mail processing systems, however, presents other issues that must be taken into consideration. For example, standard ink jet print heads must be stopped occasionally in order to perform maintenance routines. In particular, “drop-on-demand” style ink jet print heads are known to require periodic maintenance. Maintenance may include a “print head wipe” that occurs approximately every 500 prints, and has a duration of approximately 3 seconds. Maintenance also may include a “print head purge” that occurs after approximately every 3000 prints, and has a duration of approximately 14 seconds. Such maintenance requires the printing module to be inactive, i.e., not perform any print operations, for the period of time required to perform the maintenance. In high speed mail processing systems that can process mail pieces at rates up to 22,000 mail pieces per hour, it is necessary to stop the system completely to allow these maintenance periods to occur. Because of the high volume of mail pieces processed, even very short periods of down-time for maintenance can significantly impact the throughput of the system. For example, halting a system that typically processes 22,000 pieces per hour for only two minutes will reduce the throughput by 733 pieces per hour. If the maintenance is required to be performed at least once per hour, in an eight hour day the throughput of the machine will be decreased by almost 6,000 pieces. To minimize any down-time of the system, it is known to place two print heads or modules (collectively referred to hereinafter as print or printing modules) in series along the transport path, where only one of the printing modules is activated at a time. Thus, when one of the printing modules requires maintenance operations, it can be inactivated and the other printing module activated to print on the mail pieces. For example, if the first printing module requires maintenance, the first printing module is inactivated and the second printing module is activated. Mail pieces will pass through the first printing module, without being imprinted upon, to the second printing module, where printing will occur. When the second printing module requires maintenance, the second printing module is inactivated and the first printing module is activated. Mail pieces will be imprinted upon by the first printing module and will pass through the second printing module without being imprinted with any information.

The use of multiple printing modules in series, while alleviating the problem of reduced throughput, introduces new issues for the mail processing system. For example, the use of multiple printing modules has also required the use of multiple control devices (with embedded PSDs) to maintain the security of a closed system meter in which the PSD and printer are typically located within a single secure housing. In this environment, the communications between the PSD and the printing module are typically physically secure and can prevent attacks by unscrupulous people attempting to defraud the postal authority of funds. Such attacks could include, for example, replay attacks or parallel printing attacks. In a replay attack, a monitoring/recording device, such as, for example, a personal computer or other device capable of monitoring and recording the data, e.g., an indicium message, being sent between the PSD and printing module, is inserted between the PSD and printing module. Such insertion can typically be performed by splicing into or otherwise altering the communication link. The recording device logs all indicium messages, i.e., the data representative of postage indicium, generated by the PSD that is being sent to the printing module and then forwards the indicium message to the printing module. The printing module will process the indicium message and print the corresponding indicium onto a mail piece. The recorded data can then be replayed to the printing module and the same indicium or indicia will be printed again, as the printing module is unaware that the indicia data is not coming directly from the PSD and is a recording of data previously processed. Thus, the indicium data could be replayed multiple times, with postage being accounted for and paid only once, i.e., for the initial mail run that was recorded by the recording device. In a parallel printing attack, multiple printing modules are coupled to the PSD simultaneously. The connection of multiple printing modules can be performed by splicing into or otherwise altering the communication link or associated connectors. When the PSD generates indicium data and outputs an indicium message, each printing module connected to the PSD will print a copy of the indicium on a different mail piece. Thus, if there are n printing modules coupled to the PSD, the same indicium will be printed on n mail pieces, while postage is only accounted for once. The postal authority will therefore be defrauded of an amount of funds equal to (n-1) multiplied by the postage value of the indicium for each indicium generated utilizing such a parallel printing attack.

While the use of a corresponding PSD for each printing module maintains the integrity and security of the indicium printing process by securing the communication lines to prevent attacks such as those described above, it adds significantly to the complexity of the high speed mail processing system. For example, the user must now be responsible for the operation, maintenance and servicing of two separate postage meters. In addition, the use of two separate postage meters can add significantly to the cost of the mail processing system, as well as increase the amount of physical space required to accommodate both meters.

Thus, there exists a need for a high speed mail processing system that utilizes multiple printing modules without adding to the complexity, cost or size of the system while still maintaining the integrity and security required for printing indicia.

### SUMMARY OF THE INVENTION

The present invention alleviates the problems associated with the prior art and provides methods and systems for utilizing a single postal security device in conjunction with multiple printing modules, thereby not adding complexity, cost or size to the system, while still maintaining the integrity and security required for printing indicia.

In accordance with embodiments of the present invention, a high speed mail processing system having multiple printing modules is provided with a single control unit, having an embedded postal security device (PSD). The control unit is coupled to each of the printing modules through a multiplexer that is capable of switching between each of the printing modules. During initialization of the system for each mail processing session, the control unit establishes a secure communication session with each printing module individually through the multiplexer. The secure communication session established with each printing module provides protection against both parallel printing and replay attacks. Thus, the control unit can generate and provide indicia that can be printed only on the specific printing module that is currently in use. The multiplexer can switch between printing modules during operation of the mailing system, thereby always keeping one printing module in use while allowing the printing module that is not currently being used to perform any necessary maintenance operations, without having to stop the processing of mail pieces.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate a presently preferred embodiment of the invention, and together with the general description given above and the detailed description given below, serve to explain the principles of the invention. As shown throughout the drawings, like reference numerals designate like or corresponding parts.

FIG. 1 illustrates in block diagram form a portion of a mail processing system according to an embodiment of the present invention; and

FIGS. 2A and 2B illustrate in flow chart form an example of the processing of mail pieces performed by the mail processing system of FIG. 1.

### DETAILED DESCRIPTION OF THE PRESENT INVENTION

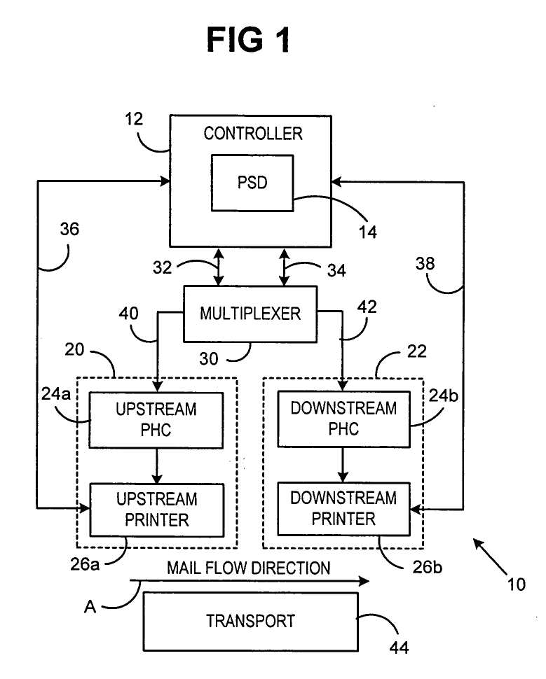

In describing the present invention, reference is made to the drawings, wherein there is seen in FIG. 1 a portion of a mail processing system 10 according to an embodiment of the present invention. It should be noted that while the following description is being made with respect to a mail processing system, the present invention is not so limited and can be utilized in any type of high speed document printing system that generates and prints evidence of some type of payment. System 10 includes a control unit, referred to herein as controller 12, that preferably includes one or more controller units, such as, for example, a microprocessor, general or special purpose processor or the like, to control operation of the mail processing system 10. Specifically, the controller 12, in conjunction with one or more other processors or controllers (not shown), provides all user interfaces, executes control of the mail processing system 10, calculates postage for debit based upon rate tables, provides the conduit for an associated Postal Security Device (PSD) 14 to transfer postage indicia for printing, operates with peripherals for accounting, printing and weighing, and conducts communications with a data center for postage funds refill, software download, rates download, and market-oriented data capture. The PSD 14, which is preferably embedded in the controller 12, contains one or more registers that store the accounting information concerning usage, such as, for example, an ascending register, descending register, piece count register, and the like. The controller 12, in conjunction with the embedded PSD 14, provides the system meter that satisfies U.S. and international postal regulations regarding closed system information-based indicia postage (IBIP) meters.

Mail processing system 10 further includes two printing modules: an upstream printing module 20 and a downstream printing module 22. The printing modules 20, 22 preferably utilize digital printing technology. The printing modules 20, 22 are coupled to the controller 12 through a multiplexer 30. The multiplexer 30 controls which printing module 20, 22 is coupled to the controller 12 and can switch between the printing modules 20, 22 based on a control signal from the controller 12 via data line 32. Data from the controller 12 is transmitted to the multiplexer 30 via data line 34. Each printing module 20, 22 includes a respective print head controller (PHC) 24a, 24b and a respective printer 26a, 26b. Data is transmitted to a respective printing module 20, 22 via data lines 40, 42, respectively. Each printer 26a, 26b is also coupled directly to the controller 12 via data lines 36 and 38, respectively. A transport 44, including, for example, rollers and/or belts, is utilized to transport mail pieces along a transport path through the mail processing system 10 in the direction indicated by arrow A. The printing modules 20, 22 are arranged serially along the transport path. The transport 44 will transport the mail pieces past the printing modules 20, 22 such that printing by one of the printing modules 20, 22 can occur on each mail piece. Sensors (not shown) located along the transport 44 provide signals to the controller 12 to indicate the position of a mail piece on the transport 44. Only one of the printing modules 20, 22 is activated at a time. Thus, when one of the printing modules 20, 22 requires maintenance operations, it can be inactivated and the other printing module activated to print on the mail pieces. For example, if the printing module 20 is currently activated and requires maintenance, the printing module 20 is inactivated and the printing module 22 is activated. Mail pieces will pass through the printing module 20, without being imprinted upon, to the printing module 22, where printing will occur. When the printing module 22 requires maintenance, the printing module 22 is inactivated and the printing module 20 is activated. Mail pieces will be imprinted upon by the printing module 20 and will pass through the printing module 22 without being imprinted with any information.

Alternatively, the printing modules 20, 22 can be arranged in a parallel fashion and mail pieces diverted to the printing module that is currently activated. When the currently active print module requires maintenance, it can be deactivated, the other print module activated, and the mail pieces diverted along the transport path to pass under the currently active printing module.

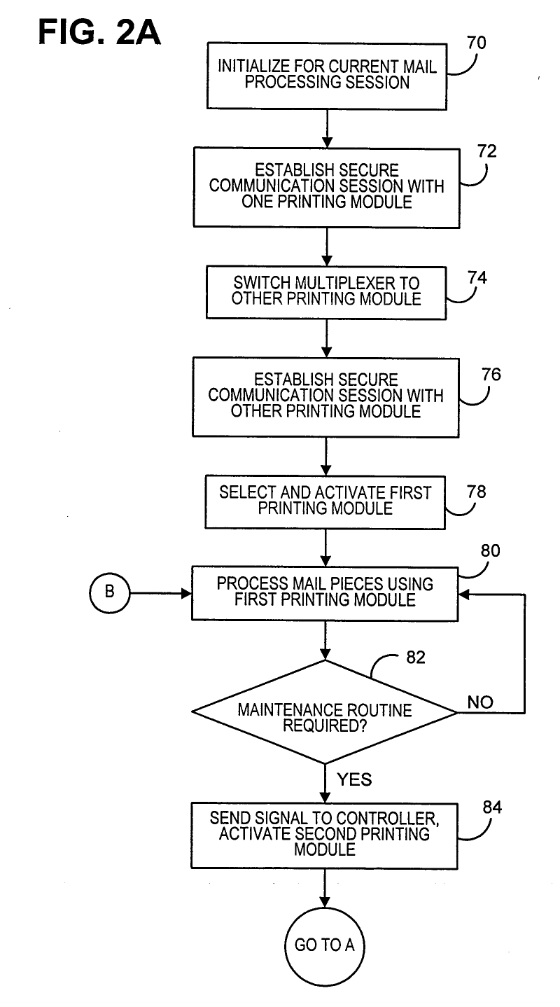

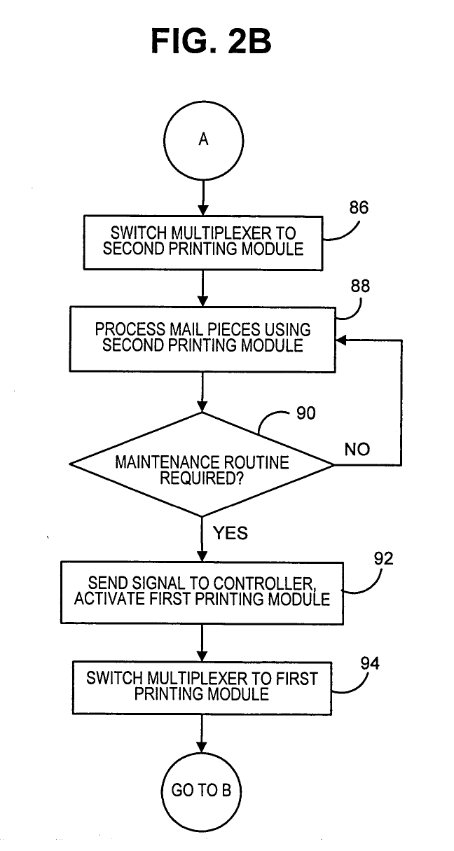

Referring now to FIGS. 2A and 2B, there is illustrated in flow chart form an example of the processing of mail pieces performed by the mail processing system 10 of FIG. 1. Mail processing system 10 utilizes a single controller 12, with a single embedded PSD 14, to generate and provide indicia in the form of indicium messages to a selected one of the printing modules 20, 22 for printing on mail pieces, thereby significantly reducing the complexity, cost and size of mail processing system 10 as compared with conventional mail processing systems that required two separate control units and postal security devices. In step 70, the mail processing system 10 begins initialization for the current mail processing session. Such initialization preferably occurs each time the mail processing system 10 is powered on, at predetermined regular intervals, e.g., daily, or based on operator request at any time. In step 72, the PSD 14, through the controller 12, establishes a secure communication session with a first one of the printing modules 20, 22. The secure communication session provides security against both replay attacks and parallel printing attacks on the system 10. For example, the secure communication session provides assurances that communications, such as, for example, an indicium message generated by the PSD 14, sent from the controller 12 will only be acted upon by the printing module 20, 22 for which they are intended (thereby preventing a parallel attack), and that the communications from the controller 12 correspond to the current mail processing session and not a previous mail processing session (thereby preventing a replay attack).

Establishing a secure session can be performed, for example, in the following manner. Suppose, for example, the PSD 14/controller 12 is establishing a secure session with the printing module 20. The printing module 20 provides the controller 12 with an identification number. The identification number can be a serial number or the like of the printing module 20, preferably unique to the printing module 20, or a random number, which can be generated by the printing module 20 or controller 12. The PSD 14 will include the identification number in each indicium message intended for the printing module 20. Optionally, the indicium message can be digitally signed by the PSD 14. When the printing module 20 receives an indicium message, the printing module 20 will verify the signature (if the message is signed) and compare the identification number in the indicium message to the identification number originally established. If the identification number is identical, the printing module 20 will act upon the indicium message, e.g., print the indicium. If the identification number is not identical or the signature is not verified, the printing module 20 will not print the indicium. Thus, an indicium message, generated by the PSD 14, from the controller 12 will only be acted upon by the printing module 20 for which it is intended, thereby preventing a parallel attack. To prevent a replay attack, “freshness” data, i.e., data unique to each mail processing session, is included along with each indicium message generated by the PSD 14 and sent from the controller 12 to the printing modules 20, 22, thereby enabling the printing modules 20, 22 to detect “stale” indicium data, i.e., indicium data that was previously generated and is being replayed, and prohibit the printing of duplicate indicia. The freshness data can include, for example, a random nonce generated by the PSD 14 or the printing modules 20, 22 during initialization that changes each time the system 10 is power cycled or a new mail processing session requested. Thus, if the system 10 is power cycled, a new nonce will be generated. If the nonce included with a current indicium message is not the same as the nonce for the current power-on session, the printing module 20, 22 that receives the indicium message will not print it. Thus, any indicium data generated during a previous power on session will not be printed.

Once a secure communication session has been established in step 72 between the PSD 14 and the printing module 20, then in step 74 the controller 12 will cause the multiplexer 30 to switch to the other printing module, e.g., printing module 22, via a signal on the data line 32. In step 76, the PSD 14 establishes a secure communication session with the other printing module, which in the example above would be printing module 22. This can be performed similarly as described above with respect to establishing a secure communication session with printing module 20. Note that the identification number and nonce for the printing module 22 is preferably different than the identification number and nonce for the printing module 20. Thus, system 10 provides protection against attacks using both the integral printing modules 20, 22 as well as external printing modules. The secure communication session for each of the printing modules 20, 22 will remain active for the current mail processing session. In step 78, the controller 12 will select and activate one of the printing modules 20, 22 to print on mail pieces. For example, the controller 12 can select the printing module 22, since the multiplexer 30 is already set such that the controller 12 is coupled to the printing module 22. It should be understood, of course, that the controller 12 could also select the printing module 20 and switch the multiplexer 30 accordingly.

The printer 26b of the selected printing module 22 will receive an activation signal from the controller 12, via data line 38, and in response move its print head (not shown) into a printing position. In step 80, printing module 22, e.g., the active printing module, is used to print on mail pieces being processed by the system 10. Controller 12, in conjunction with PSD 14, will therefore tailor any indicium messages generated to the requirements for printing module 22. This includes, for example, including the identification number and current nonce for printing module 22 in each indicium message generated by the PSD 14. The indicium messages are sent from the controller 12 to the multiplexer 30 via data line 34, and then to printing module 22 via data line 42. Printing module 22 will verify that each message received is actually intended for it to print using the identification number and nonce included in each message.

As the processing of mail pieces occurs using the printing module 22, in step 82 it is determined if printing module 22 requires that a maintenance routine be performed. Such maintenance routine can include, for example, a wipe or purging of the print head, and can be based on the number of mail pieces processed or time in use. If it is determined that a maintenance operation for the printing module 22 is not required, then processing will continue using the printing module 22. Once it is determined that printing module 22 requires a maintenance operation, then in step 84 the printer 26b will send a signal to the controller 12, via data line 38, indicating that a maintenance routine is required. Controller 12 will then send an activation signal to printer 26a of printing module 20 via data line 36, and printer 26a in response will move its print head (not shown) into a printing position. This is preferably performed while the printing module 22 is still processing mail pieces. When the printer 26a is ready to begin printing, it provides a signal to the controller 12.

In step 86, the controller 12 will signal to the multiplexer 30, via line 32, to switch from the printing module 22 to the printing module 20. This preferably occurs in between mail pieces, such that there is no disruption of operation of the system 10. In step 88, the now active printing module, e.g., printing module 20, is used to print on mail pieces being processed by the system 10. Thus, controller 12, in conjunction with PSD 14, will now tailor any indicium messages generated to the requirements for printing module 20. This includes, for example, including the identification number and current nonce for printing module 20 in each indicium message. The indicium messages are sent from the controller 12 to the multiplexer 30 via data line 34, and then to printing module 20 via data line 40. Printing module 20 will verify that each message received is actually intended for it to print using the identification number and nonce included in each message.

In step 88, controller 12 can also provide a signal to printing module 22 indicating that the printing module 22 can now perform the required maintenance operations, as it is no longer the active printing module. Thus, the printing module 22 is now able to perform a maintenance routine without the need to pause the mail processing flow, as the printing module 20 is now being used to print on the mail pieces. Processing of mail pieces will continue using the printing module 20 until in step 90 it is determined that the printing module 20 requires that a maintenance routine be performed. In step 92 the printer 26a of printing module 20 will send a signal to the controller 12, via data line 36, indicating that a maintenance routine is required. Controller 12 will then send an activation signal to printer 26b of printing module 22 via data line 38, and printer 26b in response will move its print head (not shown) into a printing position. This is preferably performed while the printing module 20 is still processing mail pieces. When the printer 26b is ready to begin printing, it provides a signal to the controller 12.

In step 94, the controller 12 will signal to the multiplexer 30, via line 32, to switch from the printing module 20 to the printing module 22. This preferably occurs in between mail pieces, such that there is no disruption of operation of the system 10. The processing then returns to step 80, where the now active printing module, e.g., printing module 22, is again used to print on mail pieces being processed by the system 10. Thus, controller 12, in conjunction with PSD 14, will now tailor any indicium messages generated to the requirements for printing module 22. In step 94, controller 12 can also provide a signal to printing module 20 indicating that the printing module 20 can now perform the required maintenance operations, as it is no longer the active printing module. Thus, the printing module 20 is now able to perform a maintenance routine without the need to pause the mail processing flow, as the printing module 22 is now being used to print on the mail pieces.

The above processing will continue, switching between printing modules 20, 22 as necessary, i.e., alternately activating and deactivating the printing modules 20, 22, until the current mail processing session ends. Thus, a mail processing system 10 having multiple printing modules 20, 22 is provided with a single control unit 12, having an embedded postal security device 14 (PSD). The control unit 12 is coupled to each of the printing modules 20, 22 through a multiplexer 30 that is capable of switching between each of the printing modules 20, 22. During initialization of the system 10 for each mail processing session, the control unit 12 establishes a secure communication session with each printing module 20, 22 individually. The secure communication session established with each printing module 20, 22 provides protection against both parallel printing and replay attacks. Thus, the control unit 12 can generate and provide indicia that can be printed only on the specific printing module that is currently in use. The multiplexer 30 can switch between printing modules 20, 22 during operation of the mailing system 10, thereby always keeping one printing module in use while allowing the printing module that is not currently being used to perform any necessary maintenance operations, without having to stop the processing of mail pieces. Those skilled in the art will also recognize that various modifications can be made without departing from the spirit of the present invention. For example, any number of printing modules can be utilized, positioned either serially or in parallel, or a combination thereof.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description.

What is claimed is:

1. A method of processing items with a processing system having a control unit and a first and second printing module coupled to the control unit via a multiplexer, the control unit including an associated payment security device, the method comprising:
establishing a secure communication session between the control unit and the first printing module via the multiplexer;
switching the multiplexer from the first printing module to the second printing module and establishing a secure communication session between the control unit and the second printing module;
alternately activating and deactivating the first and second printing modules to print evidence of payment generated by the control unit and associated payment security device on the items being processed;
generating, using the control unit and associated payment security device, evidence of payment; and
sending, from the control unit to the currently activated printing module via the multiplexer, a message including the evidence of payment, the message being based on the secure communication session established with the currently activated printing module.

2. The method of claim 1, wherein alternately activating and deactivating the first and second printing modules further comprises:
activating the first printing module;
determining if the first printing module requires a maintenance operation; and
if the first printing module requires a maintenance operation, activating the second printing module and deactivating the first printing module.

3. The method of claim 2, wherein activating the second printing module further comprises:
switching the multiplexer from the first printing module to the second printing module.

4. The method of claim 2, wherein alternately activating and deactivating the first and second printing modules further comprises:
determining if the second printing module requires a maintenance operation; and
if the second printing module requires a maintenance operation, activating the first printing module and deactivating the second printing module.

5. The method of claim 4, wherein activating the first printing module further comprises:
switching the multiplexer from the second printing module to the first printing module.

6. The method of claim 1, wherein establishing a secure communication session between the control unit and first printing module further comprises:
providing an identification number for the first printing module.

7. The method of claim 6, wherein the identification number is a randomly generated number.

8. The method of claim 6, wherein when the first printing module is activated, the message including the generated evidence of payment includes the identification number for the first printing module.

9. The method of claim 1, wherein establishing a secure communication session between the control unit and first printing module further comprises:
providing freshness data for the first printing module.

10. The method of claim 9, wherein when the first printing module is activated, the message including the generated evidence of payment includes the freshness data for the first printing module.

11. The method of claim 1, further comprising:
verifying, at the activated printer, that the message including the generated evidence of payment is based on the secure communication session established between the control unit and the activated printing module; and
upon successful verification, printing the generated evidence of payment using the activated printing module.

12. The method of claim 11, wherein if the verification is not successful, the activated printing module will not print the generated evidence of payment.

13. The method of claim 1, wherein the items are mail pieces, the processing system is a mail processing system, the payment security device is a postal security device and the evidence of payment is evidence of postage payment.

14. A document processing system comprising:
a control unit having an associated payment security device to generate and account for evidence of payment associated with each document;
a multiplexer coupled to the control unit;
a first printing module coupled to the multiplexer; and
a second printing module coupled to the multiplexer,
wherein the control unit is adapted to establish a secure communication session with each of the first printing module and the second printing module via the multiplexer and alternately activate and deactivate the first and second printing modules to print evidence of payment generated by the control unit and associated payment security device on the documents being processed, the control unit being further adapted to generate evidence of payment and send to the currently activated printing module, via the multiplexer, a message including the evidence of payment, the message being based on the secure communication session established with the currently activated printing module.

15. The processing system of claim 14, further comprising:
a transport for transporting the documents in a transport direction,
wherein the first and second printing modules are located serially along the transport direction, the second printing module being located downstream of the first printing module in the transport direction.

16. The processing system of claim 14, wherein the documents are mail pieces and the processing system is a mail processing system.

17. The processing system of claim 16, wherein the payment security device is a postal security device and the evidence of payment is evidence of postage payment for the mail pieces.
